(19) United States
(12) Patent Application Publication
(10) Pub. No.: US 2011/0163835 A1
(43) Pub. Date: Jul. 7, 2011

(54) WINDING FOR A TRANSFORMER

(75) Inventors: Karl-Heinz ZILLMANN, Marsberg (DE); Wolfgang Mönig, Brilon (DE); Benjamin Weber, Winterberg (DE)

(73) Assignee: ABB AG, Mannheim (DE)

(21) Appl. No.: 13/005,844

(22) Filed: Jan. 13, 2011

Related U.S. Application Data
(63) Continuation of application No. PCT/EP2009/000411, filed on Jun. 9, 2009.

(30) Foreign Application Priority Data
Jul. 15, 2008 (DE) 10 2008 033 123.6

(51) Int. Cl. H01F 27/28; H01F 41/06

(52) U.S. Cl. 336/222; 29/602.1

(57) ABSTRACT

A transformer has a coil including a plurality of layers of wound conductive material and layers in between made of wound insulation material. The layers of insulation material are wound in stages. The layers of insulation material are applied at an angle to the winding axis of the coil.

### RELATED APPLICATIONS

This application claims priority as a continuation application under 35 U.S.C. §120 to PCT/EP2009/004119, which was filed as an International Application on Jun. 9, 2009 designating the U.S., and which claims priority to German Application 10 2008 033 123.6 filed in Germany on Jul. 15, 2008. The entire contents of these applications are hereby incorporated by reference in their entireties.

### FIELD

The present disclosure relates to a winding for a transformer. More particularly, the present disclosure relates to a high-voltage winding for a transformer, and to a method for producing such a winding.

### BACKGROUND INFORMATION

A winding for a transformer or a coil for such a transformer is formed from one or more conductors in the form of ribbons, and an insulating material stratum of insulating material in the form of a ribbon, which are together wound around a winding core to form turns. The individual turns of the winding have a predetermined winding angle with respect to the winding axis of the winding core, and are arranged with respect to one another such that they partially overlap one another. An insulating stratum being inserted between two radially adjacent layers of turns composed of electrically conductive material.

In this case, it is possible to provide one or more layers of turns composed of electrically conductive material. These layers which are located radially one on top of the other form a multilayer transformer or a multilayer coil. The insulating stratum between the conductors prevents voltage flashovers between the layers, and is accordingly designed for the greatest voltage difference which will occur between two layers.

DE 101 57 591 A1 describes an arrangement of insulating material, in which the insulating material is wound in a stepped manner, such that the thickness of the insulating material varies in the axial direction. Depending on the voltage difference between each of the individual layers of the turns composed of electrically conductive material, the insulating stratum is thicker at one axial end of the coil than at the other end. The insulating stratum between the two following layers composed of electrically conductive material has a greater radial thickness at the point at which the first layer is thinnest while, in contrast, the other end of the layer is located in the area in which the layer located underneath it is at its thickest. In this case, the conductor material and the insulation for the winding are applied and wound at the same time (i.e., simultaneously). The roving fibers for the insulating stratum may be formed in the circumferential direction and at an angle to the winding axis (radial assemblies and crossed-over assemblies).

When the conductor material and the insulation are wound at the same time, particularly if the aim is to apply increasing layer insulation, it is difficult to introduce reinforcement in the axial direction, because all the fibers run in the circumferential direction.

### SUMMARY

An exemplary embodiment provides a transformer. The exemplary transformer includes a coil which has a plurality of layers of wound conductor material and layers of wound insulating material between the layers of conductor material. The layers of insulating material are wound in a stepped manner from insulating material, and the layers of insulating material are applied at an angle to a winding axis of the coil.

An exemplary embodiment provides a method for producing a transformer. The exemplary method includes applying layers of insulating material between each pair of two layers of wound conductor material. The layers of insulating material are applied at an angle to a winding axis of a coil.

### BRIEF DESCRIPTION OF THE DRAWINGS

Additional refinements, advantages and features of the present disclosure are described in more detail below with reference to exemplary embodiments illustrated in the drawings, in which:

FIG. 1 shows a longitudinal section view through a winding according to an exemplary embodiment of the present disclosure,

FIG. 2 shows an example of the alignment of an insulating material ribbon according to an exemplary embodiment of the present disclosure, and

FIG. 3 shows a schematic illustration of standard equipment of a ribbon strand of insulating material, according to an exemplary embodiment of the present disclosure.

### DETAILED DESCRIPTION

Exemplary embodiments of the present disclosure provide a transformer and method for producing the transformer. The transformer includes a coil which has a plurality of layers of wound conductor material and layers of wound insulating material between the layers of conductor material. The layer insulation is applied so that force is also absorbed in the axial direction.

According to an exemplary embodiment, the production of stepped layer insulation is produced by the rovings being wound not only in the circumferential direction but also being applied at an angle obliquely to the winding axis. In this case, the support for the supply of the layer insulation is moved in a reciprocating manner, e.g., pushed forward and moved back in the axial direction, with this being able to be done such that stepped insulation, or insulation which increases in a straight line, is created at the same time. During this process, the insulation approaches ever closer to insulation which actually increases in a linear form, as the number of steps is increased.

The insulation material might be either a glass roving or a polyester roving, which is impregnated with casting resin, for example. However, the insulating material may also be impregnated with a resin in the so-called B-state, in which the resin is still liquid, possibly with an expanding filler. Non-wovens or woven ribbons could also be used as insulation materials. The term “fiber rovings” therefore covers all possible suitable materials, and materials with a similar effect.

In order to produce the layers of insulating material, fiber rovings are applied, and are applied obliquely with respect to the winding axis.

In this case, the layers of insulating material, which are formed by fiber rovings, are applied in a crossed-over manner at least in the step areas, which have a greater radial layer thickness, that is to say in particular those at the respective end of the coil.

The layers of insulating material may in this case be applied by moving the coil past the supply point; it is, of course, also possible for the supply point to be moved with respect to the stationary coil.

In order to produce a crossed-over layer, the fiber roving supply can be moved in a reciprocating manner, in the direction of the winding axis.

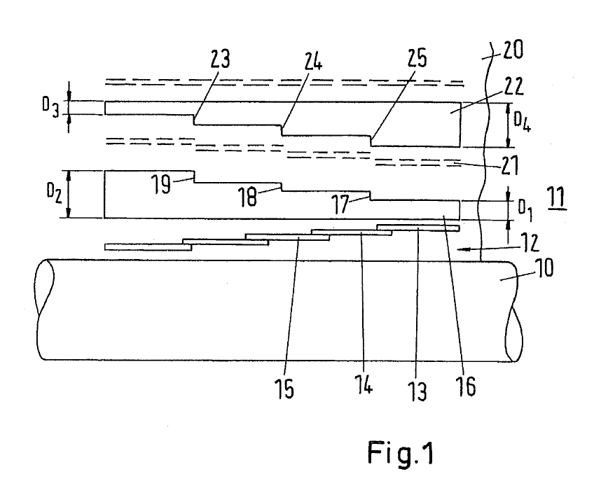

FIG. 1 shows a longitudinal section view through a winding according to an exemplary embodiment of the present disclosure. In the illustrated example, a first radially inner layer 12 of conductor material is wound onto a core 10 of a coil 11, and is formed from a plurality of layer sections 13, 14, 15, with the individual layer sections 13, 14, 15 covering one another. In the exemplary embodiment of FIG. 1, a conductor ribbon material is illustrated as the conductor material. Conductors with a round or rectangular cross section could also be used, for example. To this extent, the present disclosure is not restricted to conductor ribbon material. A layer 16 of insulating material is wound onto the radially inner layer 12 of the electrical conductor material and is wound with steps, in which case the thickness D₁ at the right-hand end (in the example of FIG. 1) is small in accordance with the requirements for the voltage carrying capability, while in contrast the thickness D₂ of the insulating layer 16 is greater at the left-hand end in the drawing. In-between, there are a plurality of steps 17, 18 and 19, dependent on the axial length of the winding, which is annotated overall with the reference number 20.

A radially outer second layer 21 of electrically conductive material, formed in the same way as the layer 16, is located on the layer 16 composed of insulating material. An outer layer 22 of insulating material, which is applied to the radially outer second layer 21, is formed in a similar manner to the layer 16, but with the radial thickness D₃ being in the area in which the layer 16 with the greatest thickness D₂ is located. At the other end (e.g., on the right in the example of FIG. 1), the layer of insulating material 22 has the radial thickness D₄, with steps 23, 24, 25 also being provided here.

As described in DE 101 57 591 A1, the radial thickness of the insulating layers 16 and 22 is designed to correspond to the voltage difference between two layers of conductive material.

As shown in FIG. 3, in order to produce the layers 16 and 22, roving ribbon 30 composed of insulating material is wound on such that the roving strand 30 runs exactly in the circumferential direction, which represents a standard version.

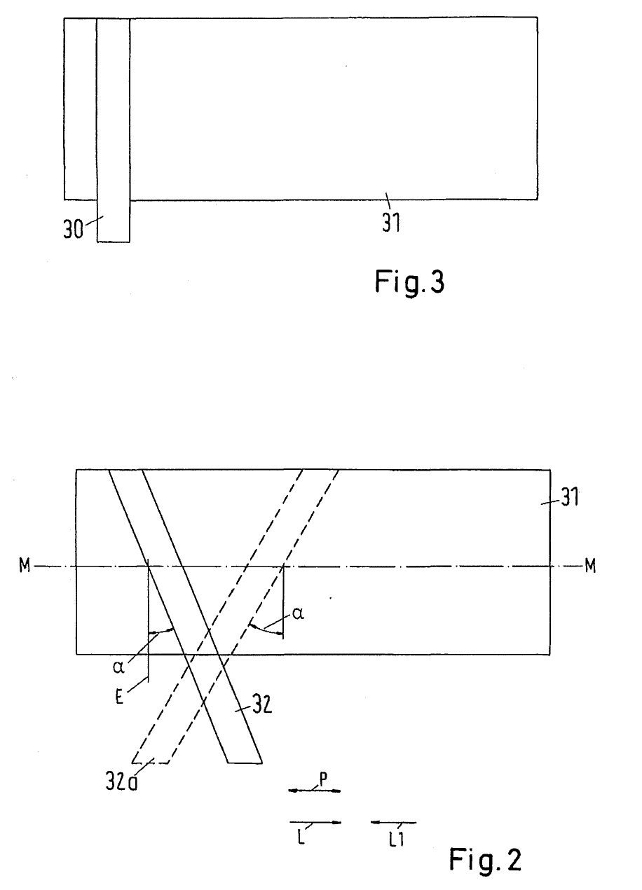

In accordance with an exemplary embodiment, the layers according to the present disclosure as shown in FIG. 1 can be produced as follows. A ribbon 32 of electrically insulating material, e.g., a roving ribbon, is applied as shown in FIG. 2 onto a coil former 31 or a coil 31, and runs at an angle α to a plane E which runs at right angles to the longitudinal axis M-M of the coil 31. In this case, the roving ribbon 32 can be moved in a reciprocating manner, as a result of which, as illustrated by dashed lines at 32a, the angle a runs on both sides of a plane which is aligned at right angles to the center axis M-M. In other words, the roving ribbon 32 can be wound onto the coil 31 in a zigzag alignment by moving a support in a reciprocating manner in the direction of the double-headed arrow P. It is, of course, also possible, depending on the form of the angle α, for the association of the ribbon 32 with the coil 31 to always run in the same direction, as is illustrated in the drawing in FIG. 2.

The steps 17, 18, 19 and 22, 23, 24 can be produced in the same way with the refinement with the roving ribbon 32 being moved in a reciprocating manner, in which case the angle α can be made sufficiently small.

The reciprocating movement of the support as shown by the direction of the arrow P may, of course, also be designed such that linear, wedge-shaped insulation can be produced in addition to stepped insulation. In this case, the times for which the insulation support remains at the points with thick layer insulation can be chosen to be greater, as is also the case for stepped insulation layers, for example. In this case, a greater number of steps would make it possible to approach insulation which is linear in the form of a wedge.

In accordance with an exemplary embodiment, the support carries out not only the movement P in the direction of the double-headed arrow but also an additional longitudinal movement in the direction of the arrow L, or in the opposite direction L1, to cover the entire length of the coil 31.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A transformer comprising:
a coil which has a plurality of layers of wound conductor material and layers of wound insulating material between the layers of conductor material,
wherein the layers of insulating material are wound in a stepped manner from insulating material, and the layers of insulating material are applied at an angle to a winding axis of the coil.

2. The transformer as claimed in claim 1, wherein the layers of insulating material are applied in a crossed-over manner at least in the step areas.

3. A method for producing a transformer, the method comprising:
applying layers of insulating material between each pair of two layers of wound conductor material,
wherein the layers of insulating material are applied at an angle to a winding axis of a coil.

4. The method as claimed in claim 3, wherein the layers of insulating material are applied in a crossed-over manner.

5. The method as claimed in claim 3, wherein a supply point for the layers of insulating material is moved past the coil.

6. The transformer as claimed in claim 2, wherein the layers of insulating material are applied in the step areas having a greater radial layer thickness than other areas of the coil.

7. The method as claimed in claim 4, wherein a supply point for the layers of insulating material is moved past the coil.

8. The method as claimed in claim 3, wherein the layers of insulating material are applied in step areas having a greater radial layer thickness than other areas of the coil.

9. The method as claimed in claim 3, wherein the the layers of insulating material are wound in a stepped manner.
